(19) United States
(12) Patent Application Publication
(10) Pub. No.: US 2016/0315457 A1
(43) Pub. Date: Oct. 27, 2016

(54) Rodent Sleeve Guard for Cables and Method of Making Same

(71) Applicant: Robert Winer, Akron, OH (US)

(72) Inventor: Robert Winer, Akron, OH (US)

(21) Appl. No.: 15/134,853

(22) Filed: Apr. 21, 2016

Related U.S. Application Data
(60) Provisional application No. 62/152,208, filed on Apr. 24, 2015.

(51) Int. Cl. H02G 9/06; F16L 57/00; H02G 3/04

(52) U.S. Cl. CPC H02G 9/065; H02G 3/04; F16L 57/00

(57) ABSTRACT

Devices for repelling or discouraging rodents from accessing wires or cables on utility poles are presented, along with the method of manufacturing the same. According to preferred embodiments of the invention, a rodent-repellent additive is blended with a thermoplastic elastomer or rubber and then extruded into a tubular member that may be placed around existing cables and wires maintained by a utility pole. A squirrel or other rodent typically desiring to gnaw on the insulation or the wires themselves will be discouraged from such activity by the odor attendant to the material from which the tubular member or sleeve guard is manufactured. If not so discouraged, the taste of the material will conclusively discourage such activity. That same material may be extruded in the form of a flat, elongated extrudate cut to length to form bands that may be placed about the utility pole beneath areas requiring protection from squirrels or the like.

### CROSS-REFERENCE

This application claims priority of U.S. Provisional Patent Application No. 62/152,208, filed Apr. 24, 2015, by the same title.

### TECHNICAL FIELD

The invention herein resides in the art of protective devices and, more particularly, to a shield that may be placed about transmission wires, cables and the like to discourage rodents from accessing such cables and damaging them by gnawing or chewing on them. The invention is particularly directed to a rodent sleeve guard that can be placed upon such existing cables not only to enclose or encase the cables, but also to repel rodents from engaging the cables. The invention also relates to the method of making such a sleeve guard.

### BACKGROUND OF THE INVENTION

It is well known that rodents such as mice, rats, squirrels and the like often chew or gnaw upon cables and wires, and particularly the insulation enclosing such cables and wires. It is generally understood that these rodents chew or gnaw on the cables and wires as a feeding activity, but it is also known that this activity is engaged by the rodents to wear down their incisor teeth, which are constantly growing. Regardless of the purpose of this rodent activity, the damage to the wires and cables can often be significant. In the case of power lines, short circuits and power outages can occur, the same being costly and inconvenient to both individuals and businesses. In the case of data transmission lines, such as fiber-optic cables and the like, the interruption to business activity resulting from down time and lost data can be significant. Moreover, and in any event, the time and cost incident to locating the failure site and effecting repair is significant.

Cables and wires strung between utility poles are particularly susceptible to access by squirrels. The squirrels may access the wires and cables strung between such utility poles by climbing trees and gaining access to the wires mid-span from branches closely adjacent to the wires or cables. They also typically climb the utility poles and access the wires at the point of interconnection/support at the pole. Utility companies typically trim and clear tree branches in close proximity to the strung wires and cables for purposes of preventing shorts and the like. This trimming activity has the added benefit of impeding mid-span access to the wires by squirrels. However, wooden utility poles are quite inviting to squirrels seeking access to the wires. Indeed, it has been found that much damage has been done to wires at the point of interconnection/support on the arms of utility poles, and that other damage has been done by squirrels to equipment mounted to the utility poles above their outstretched arms.

There is a need in the art for an apparatus and methodology for effectively isolating wires and cables from squirrels and to do so in a cost-effective manner.

There is a particular need in the art for an apparatus and methodology that not only protects the wires and cables physically, but also renders them unattractive to the squirrels—and actually renders them offensive to the squirrels—such that squirrels do not seek access to the cables or wires.

### DISCLOSURE OF INVENTION

In light of the foregoing, it is a first aspect of the invention to provide a rodent sleeve guard for cables that physically precludes the squirrels from accessing the wires or cables.

Another aspect of the invention is the provision of a rodent sleeve guard that can be received by wires and cables that is offensive to sensory perceptions of squirrels, discouraging them from making any damaging access to the wires and cables.

Still another aspect of the invention is the provision of a rodent sleeve guard that provides an offensive odor detectable to squirrels, but undetectable by human beings.

Still a further aspect of the invention is the provision of a rodent sleeve guard made of a material that has a characteristic offensive taste when chewed by a rodent, such as a squirrel.

Yet another aspect of the invention is the provision of a rodent sleeve guard that is easy to install and, once installed, remains in place until removed by an operator.

An additional aspect of the invention is the provision of a rodent sleeve guard that is substantially impervious to degradation by sunlight and weather.

Still another aspect of the invention is the provision of a rodent sleeve guard for cables and the like that is cost-effective in implementation.

Still another aspect of the invention is the provision of a method for making a rodent sleeve guard having the benefits mentioned above.

The foregoing and other aspects of the invention as will become apparent herein are achieved by a cover guard for repelling rodents, comprising an elongated member formed from a composition of a base material blended with a rodent repellent. Other aspects of the invention are achieved by a sleeve guard for protecting wires and cables from damage by rodents, comprising a tube formed from a base material blended with a rodent repellent, said tube being longitudinally slit open between opposite ends thereof, and wherein said base material blended with said rodent repellent is flexible and recoverable to an unflexed condition. Yet further aspects of the invention are attained by a method for making rodent repellent sleeve guards for protecting wires and cables, comprising adding a first meltable composition to a heated blender; adding a second meltable composition comprising a rodent repellent to said heated blender; melting and blending said first and second meltable compositions into a blended composition; extruding said blended composition into a substantially tubular extrudate; and cooling said extrudate.

### DESCRIPTION OF DRAWINGS

The invention described herein is best understood with reference to the following drawings wherein:

FIG. 1 is a system diagram of the apparatus and methodology for making the rodent sleeve guards of the invention;

FIG. 2 is a cross-sectional view of a rodent sleeve guard made in accordance with the invention, showing the sleeve guard in its open position;

FIG. 3 is a cross-sectional view of the rodent sleeve guard of the invention showing the sleeve guard in its closed position;

FIG. 4 is a perspective view of the rodent sleeve guard of the invention in its closed position;

FIG. 5 is a perspective view of a rodent-repellent band adapted for securing about a utility pole at a desired location;

FIG. 6 is an illustration of a utility pole employing the concepts of the invention;

FIG. 7 is a perspective view of a second embodiment of a rodent sleeve guard of the invention, illustratively shown in use as snap-fit over a cable; and

FIG. 8 is a perspective view of a third embodiment of a rodent sleeve guard of the invention, illustratively shown in use as spirally wound about a cable.

### DETAILED DESCRIPTION OF ILLUSTRATIVE EMBODIMENTS

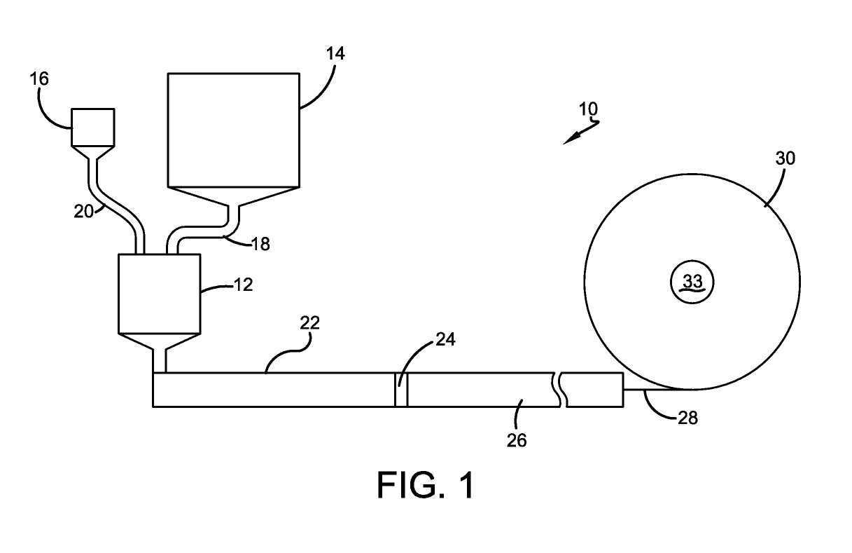

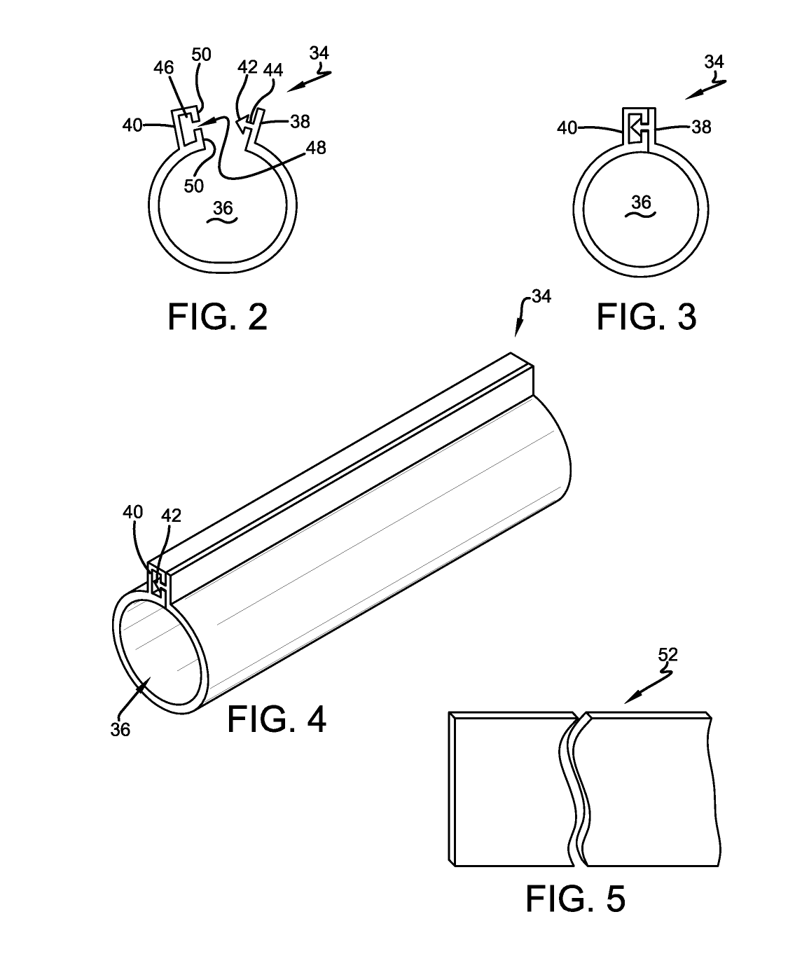

Referring now to the drawings and more particularly FIG. 1, a system for making rodent sleeve guards in accordance with the invention is shown as designated by the numeral 10. As illustrated, a heated blender or mixer 12 communicates with a pair of hoppers 14, 16 and receives associated constituent components therefrom through dispensing lines 18, 20. According to a preferred embodiment of the invention, the hopper 14 receives pellets of a high-grade, thermoplastic elastomer (TPE) that is stabilized as to ultraviolet radiation. The hopper 16 receives an additive in the form of a nontoxic rodent repellent, again presented in pelletized form. Presently, it is contemplated that the rodent repellent may be that manufactured by C Tech Corporation of Surat, India, and described in a Material Data Safety Sheet as a quaternary ammonium compound in the family of carboxylic acids, esters, and organic compounds and characterized as having a processing temperature on the order of 120-180° C. The rodent repellent is sold under the mark “RodRepel.” The rate of dispensing from the hoppers 14, 16 into the heated blender or mixer 12 is preferred to be such that the resulting compound is 2-7% by weight of the additive RodRepel, and more preferably on the order of 3% by weight. The heated blender 12 thoroughly mixes and melts the pellets dispensed through the dispensing lines 18, 20 and passes them to the extruder 22, driven by an appropriate feed screw or the like, extruding the mixture through an appropriate die plate 24 and thence through a cooling bath of water 26. The resultant extrudate 28 is then either taken up on a take-up roll 30 mounted to a motor-driven spindle 32, or the extrudate 28 can be cut to desired lengths out of the cooling bath 26 and packaged immediately. In either event, and in accordance with the invention, the extrudate 28 may either be in the form of tubular or cylindrical sleeve guards as shown in FIGS. 2-4, or in the form of a band as shown in FIG. 5, both of which will be discussed directly below. Of course, the configuration of the resultant product is dependent upon the configuration of the die plate 24 and the operational speeds of the extruder 22 and take-up roll 30.

As presented above, a preferred embodiment of the invention employs a high-grade thermoplastic elastomer (TPE) as the major component of the extrudate. It has also been found that rubber and vulcanized rubber may be employed. In all events, the blending of the nontoxic rodent repellent ingredient with the major component and the formation of the sleeve guard under pressure and at an elevated temperature appears to activate the rodent repellent ingredient and uniformly distribute its effects throughout the product. With the major component being TPE or rubber, the resulting products are electrically insulating.

With reference now to FIGS. 2-4, it can be seen that a cover or sleeve guard made in accordance with the invention and the process of FIG. 1 is designated generally by the numeral 34. The sleeve guard 34 has a natural open appearance substantially as shown in the cross-sectional view of FIG. 2, and a closed configuration as shown in the cross-sectional view of FIG. 3 and the perspective view of FIG. 4. The sleeve guard 34 is somewhat flexible so that it can be opened much wider than is shown in FIG. 2 to be placed over a wire, bundle of cables or the like, and then snapped shut as shown in FIGS. 3 and 4. When closed, the sleeve guard is of substantially cylindrical configuration and substantially circular in cross-section. The sleeve guard 34 defines a passageway 36, which becomes closed by mating engagement of male and female flanges 38, 40. As shown, the male flange 38 has an arrowhead 42 extending therefrom at the end of a ledge 44. The arrowhead 42 is substantially triangular in shape when viewed in cross-section as shown. A female flange 40 has a channel 46 communicating with a longitudinal opening 48 that is slightly smaller than the maximum width of the arrowhead 42. A pair of lips 50 extends along either side of the longitudinal opening 48, as shown.

In use, an installer simply deflects the open sleeve guard 34, as shown in FIG. 2, to have a sufficient opening to pass over the wire or cable grouping to be protected thereby. Once the cable or wire is received within the passageway 36, the operator simply pinches the flanges 38, 40 toward each other such that the male arrowhead 42 deflects past the lips 50 and into the channel 46. The tapered nature of the arrowhead 42 deflects the lips until the arrowhead passes the lips, at which time the lips snap closed upon the ledge 44 behind the arrowhead 42, achieving the locked position of FIGS. 3-4. The secured engagement remains in place regardless of wind and other ambient conditions or the like. Should an operator need to remove the sleeve guard 34 for any reason, starting at one end or the other of the sleeve guard, disengagement of the arrowhead 42 from the channel 46 and lips 50 may be readily achieved as a consequence of the flexible nature of the TPE employed.

It is contemplated that the sleeve guards 34 may be made of any appropriate length, although it has been found that a length of 15-24 inches is preferred. Most preferably, an 18-inch length has been found appropriate.

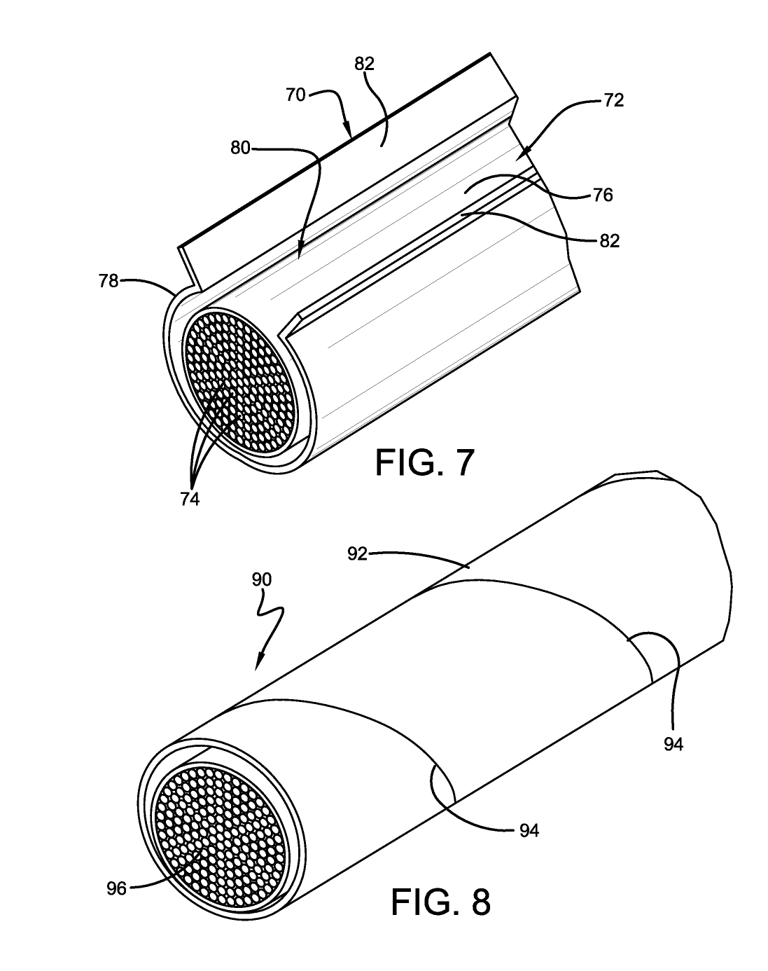

A first alternative embodiment of the sleeve guard of the invention is shown in FIG. 7 and designated generally by the numeral 70. The sleeve guard 70 is shown as being securedly received by a conductor cable 72 comprising a multitude of copper wires 74 or the like held in close contacting engagement and extending longitudinally within an appropriate insulating shield 76. The sleeve guard 70 has a substantially tubular body 78 with an open sector 80 defined between outwardly extending flanges 82. The flanges 82 are angled away from each other, defining a funneled trough to the open sector 80. The TPE or rubber from which the sleeve guard 70 is formed is expandable and flexible, but with a memory for recovery to its unflexed shape, and the open sector 80 has a width on the order of 0.7-1.2 times the inner radius of the tubular body 78. Preferably, the inner diameter of the tubular body 78 is 0.9-1.5 times the diameter of the conductor cable 72.

In use, the outwardly flared flanges 82 are brought into engagement with the insulating shield 76 of the conductor cable 72. As force is applied to the sleeve guard 70, the flared flanges 82 separate, increasing the width of the open sector 80 as the sleeve guard 70 moves downward across the shield 76. When the open sector 80 reaches the diameter of the cable 72, the sleeve guard 70 passes immediately over the remainder of the cable 72 by the force of the memory of the sleeve guard 70, bringing the open sector 80 and spacing of the flanges 82 toward their quiescent or normal position. If the diameter of the cable 72 is less than the diameter of the sleeve guard 70, the original spacing and positioning of the open sector 80 and flanges 82 will be attained. If the diameter of the cable 72 is greater than the diameter of the sleeve guard 70, the inner wall of the sleeve guard 70 will hug the outer wall of the cable 72 and the open sector 80 and flanges 82 will be spaced accordingly.

It has been found that the sleeve guard 70 is given to significant ease of use. When a portion of sleeve of a length of 1-4 feet is to be placed over a cable, as soon as one end of the sleeve guard 70 is fully placed over the cable, a quick rap or impact at about the midsection of the sleeve guard length is sufficient to cause the flanges 82 and the open sector 80 to separate sufficiently along the entire length to snap shut upon the cable, the entire operation being performed in seconds on previously installed cable.

With reference to FIG. 8, a second alternative embodiment can be seen as designated by the numeral 90. Here, a tubular member 92 formed by extruding a blend of a nontoxic rodent repellent with TPE or rubber, as aforesaid, is continuously spirally cut as at 94 so that it can be readily wrapped around a cable 96, whether the cable be conductive, a guy wire, or the like. The inner diameter of the tubular member 92 is preferably greater than the outside diameter of the cable 96. The spiral wrap is quickly and easily applied and self-seating.

Each of the embodiments presented above has been found to effectively retain its position on the associated cable during a broad range of adverse weather conditions.

Utility poles often maintain service boxes, junction boxes, and the like above the cross-arm area of the utility pole, which are often used, under lease or the like, by entities other than the utility company owning the pole. That region of the pole itself may be protected by providing cover guard in the form of a band of the material formed in the heated blender or mixer 12 by wrapping the band about the utility pole immediately beneath this area. The band can be formed by simply changing the die 24 of the extruder 22. The band will typically be of a width on the order of 5-10 inches, and preferably 8 inches, and have a length equal to at least the circumference of the utility pole at the height at which it will be attached. Attachment of the bands 52 as shown in FIG. 5 may be made by staple tacking or the like and provide a first line of defense against rodents entering the power supply area.

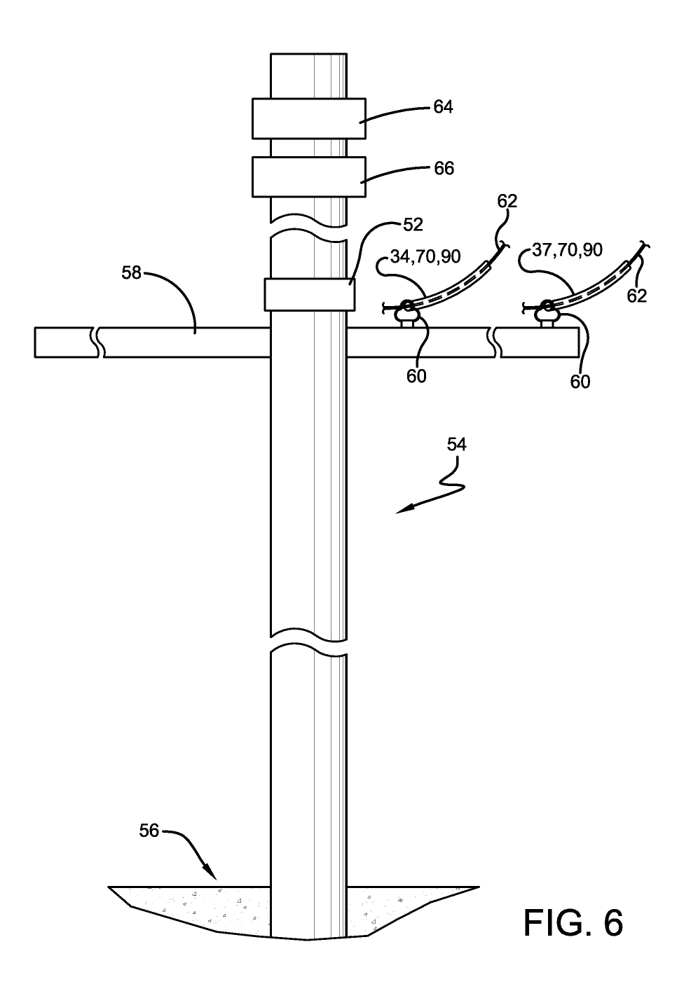

With reference now to FIG. 6, a utility pole 54 as shown is received by the ground 56 in standard or customary use. The utility pole 54 has at least one cross-arm 58 as shown. The cross-arm 58 has insulators or other appropriate connectors 60 receiving wires or cables 62 as the wires or cables are strung from pole to pole.

As shown in FIG. 6, single or multiple lengths of the rodent sleeve guards 34, 70, 90 may be applied to the respective wires or cables, dependent upon the length of protection deemed necessary. The band 52 is preferably positioned above the cross-arm 58 in the area where service boxes 64, 66 might be placed. The band 52 may be stapled or appropriately tacked to the wooden utility pole 54 to maintain it in position. It will also be appreciated that wires or cables may extend from these service boxes 64, 66 and receive the sleeve guards as just described.

The rodent-repellent material added from the hopper 16 provides an odor that is offensive to rodents, but not detectable by human beings. It has also been found that the taste of the blended material forming the sleeve guards 34, 70, 90 and the band 52 is also repulsive to rodents, although it has typically been found that the offensive odor is sufficient to discourage the rodents, particularly squirrels, from any desire to further access the cables or wires protected thereby.

In light of the foregoing, it should be appreciated that the present invention significantly advances the art by providing a device and its method of manufacture that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. Moreover, while the invention has been presented in the context of aerial cables, wires and structures, the concept of the invention is also applicable to ground-based wires, cables and devices threatened by rats, mice, squirrels and the like.

What is claimed is:

1. A sleeve guard for repelling rodents, comprising:
an elongated member formed from a composition of a base material blended with a rodent repellent.

2. The cover guard as recited in claim 1, wherein said rodent repellent is repulsive to rodents' senses of smell and taste.

3. The cover guard as recited in claim 2, wherein said rodent repellent is a quaternary ammonium compound.

4. The cover guard as recited in claim 1, wherein said elongated member is tubular and is split longitudinally from a first end of said elongated tubular member to an opposite second end thereof.

5. The cover guard as recited in claim 4, wherein said split spirals about said elongated tubular member.

6. The cover guard as recited in claim 4, wherein said split has first and second opposed lateral edges with flanges extending outwardly from each of said first and second opposed lateral edges.

7. The cover guard as recited in claim 6, wherein said flanges are characterized by mating members.

8. The cover guard as recited in claim 7, wherein said first lateral edge has a male flange and said second lateral edge has a female flange, said male and female flanges being releasably matingly engageable.

9. The cover guard as recited in claim 4, wherein said flanges extend divergently from each other from a wall of said elongated tubular members.

10. The cover guard as recited in claim 9, wherein said split comprises an open sector in said wall of said elongated tubular member.

11. The cover guard as recited in claim 10, wherein said flanges establish a trough narrowing to said open sector.

12. The cover guard as recited in claim 11, wherein said elongated tubular member is expandable and flexible, with a memory for recovery to an unexpanded or flexed shape.

13. The cover guard as recited in claim 12, further comprising a cable received within said elongated tubular member, said elongated tubular member having a diameter of 0.9-1.5 times a diameter of said cable.

14. The cover guard as recited in claim 13, wherein said open sector has a width on the order of 0.7-1.2 times an inner radius of said elongated tubular member.

15. A sleeve guard for protecting wires and cables from damage by rodents, comprising:
a tube formed from a base material blended with a rodent repellent, said tube being longitudinally slit open between opposite ends thereof, and wherein said base material blended with said rodent repellent is flexible and recoverable to an unflexed condition.

16. The sleeve guard according to claim 15, wherein said tube has outwardly extending flanges along opposite sides of said slit, said flanges being matingly engageable.

17. The sleeve guard according to claim 16, wherein mating engagement of said flanges closes said slit and longitudinally seals said tube.

18. The sleeve guard according to claim 15, wherein said slit defines an open sector and said tube has outwardly extending flanges along opposite sides of said open sector, said flanges diverging outwardly and establishing a funneled trough toward said open sector.

19. The sleeve guard according to claim 18, wherein said open sector has a width less than a radius of said tube.

20. A method for making rodent-repellent sleeve guards for protecting wires and cables, comprising:
adding a first meltable composition to a heated blender;
adding a second meltable composition comprising a rodent repellent to said heated blender;
melting and blending said first and second meltable compositions into a blended composition;
extruding said blended composition into a substantially tubular extrudate; and
cooling said extrudate.
